(19) United States
(12) Patent Application Publication
(10) Pub. No.: US 2016/0330819 A1
(43) Pub. Date: Nov. 10, 2016

(54) MULTIPLE LIGHT FIXTURE COMMISSIONING SYSTEMS AND METHODS

(71) Applicant: ABL IP Holding LLC, Conyers, GA (US)

(72) Inventor: KEVIN F. LEADFORD, Evergreen, CO (US)

(21) Appl. No.: 14/707,210

(22) Filed: May 8, 2015

(51) Int. Cl. H05B 33/08

(52) U.S. Cl. CPC H05B 33/0863; H05B 33/0845

(57) ABSTRACT

A method of commissioning a plurality of light fixtures located in a space includes controlling a user interface to provide a display of a representation of the space, and representations of each of the plurality of light fixtures. The method further includes controlling light emitted by at least a subset of the light fixtures, such that each of the light fixtures is distinguishable from others of the light fixtures, and controlling the user interface such that the representation of each of the light fixtures is distinguishable from the representations of the others of the light fixtures. The method further includes receiving input from the user interface as information that specifies a position of each of the light fixtures within the space, and storing the information that specifies the position of each of the light fixtures within the space, in a data structure.

### BACKGROUND

Man's desire for a connection to the outdoors has long been understood in architecture, as evidenced by the popularity of rooms with a view. Research has suggested that human performance improves in rooms that have the best view (largest window area, most vegetation). Disparities of similar magnitude have been posted relative to retail sales and student learning.

Certain light fixtures exist that can provide an outdoor-like user experience by providing light that mimics daylight variation from time to time within a day and from day to day within a year.

### SUMMARY

In an embodiment, a method of commissioning a plurality of light fixtures located in a space includes controlling a user interface to provide a display of a representation of the space, and representations of each of the plurality of light fixtures. The method further includes controlling light emitted by at least a subset of the light fixtures, such that each of the light fixtures is distinguishable from others of the light fixtures, and controlling the user interface such that the representation of each of the light fixtures is distinguishable from the representations of the others of the light fixtures. The method further includes receiving input from the user interface as information that specifies a position of each of the light fixtures within the space, and storing the information that specifies the position of each of the light fixtures within the space, in a data structure.

In an embodiment, a software product includes instructions stored on non-transitory computer readable media. The instructions, when executed by one or more processors, cause the one or more processors to implement steps of a method for commissioning a plurality of light fixtures located in a space. The instructions include instructions for controlling a user interface that includes a visual display, to provide a display of a representation of the space, and representations of each of the plurality of light fixtures. The instructions also include instructions for executing, for at least a subset of the light fixtures: instructions for causing light fixtures of the subset to emit light that is distinguishable from light emitted by others of the light fixtures; instructions for causing the representations of each of the subset of the light fixtures to be distinguishable from the representations of others of the light fixtures, in the visual display; and instructions for receiving input from the user interface as information that specifies a position of each of the subset of the light fixtures within the space. The instructions also include instructions for causing the information that specifies the position to be stored in a data structure.

In an embodiment, a controller for commissioning a light fixture installation includes a processor and an input/output engine communicatively coupled with the processor. The input/output engine includes a user interface having a display and an input device, and a light fixture output engine that generates commands for controlling a plurality of light fixtures. The controller also includes a memory communicatively coupled with and readable by the processor. The memory stores a light fixture data structure and processor-readable instructions that, when executed by the processor, cause the processor to display, through the user interface, a representation of a space and representations of each of the plurality of light fixtures, control one of the plurality of light fixtures, through the light fixture output engine, such that the one of the light fixtures emits light that is distinguishable from light emitted by others of the light fixtures, accept input, from the input device, as information that specifies a position of the one of the light fixtures within the space, and store the information that specifies the position, in the light fixture data structure.

### BRIEF DESCRIPTION OF THE DRAWINGS

The present disclosure is described in conjunction with the appended figures:

FIG. 1, which illustrates a room lit by illumination components of a lighting module, in accord with an embodiment.

FIG. 2 is a generalized system diagram that illustrates a lighting system, including an installation of light fixtures within a space, in accord with an embodiment.

FIG. 3 is a flowchart that illustrates a method of commissioning a lighting installation, in accord with an embodiment.

FIG. 4 provides an illustration relevant to an understanding of certain steps of the method illustrated in FIG. 3, in the context of a controller that utilizes a graphical user interface (GUI), in accord with an embodiment.

FIG. 5 schematically illustrates a lighting system as a special case of the lighting system of FIG. 2, in accord with an embodiment.

FIG. 6 illustrates a lighting system that wirelessly connects a controller with all light fixtures associated with an installation, in accord with an embodiment.

FIG. 7 schematically illustrates a lighting system that wirelessly connects a controller and a user device with multiple light fixtures, in accord with an embodiment.

FIG. 8 schematically illustrates a lighting system that connects a controller and a user device with multiple light fixtures using wired connections, in accord with an embodiment.

FIG. 9 illustrates a lighting system that wirelessly connects a controller and a user device with multiple light fixtures, with access to software and/or data facilitated by connections to the Internet, in accord with an embodiment.

FIG. 10 illustrates a lighting system that wirelessly connects a controller and a user computer with multiple light fixtures, with access to software and/or data facilitated by connections to the Internet, in accord with an embodiment.

FIG. 11 schematically illustrates a space in which two types of light fixtures are installed, of which one of the light fixture types features an orientation, and use of a GUI to capture orientation information as well as position information, in accord with an embodiment.

### DETAILED DESCRIPTION

The present disclosure may be understood by reference to the following detailed description taken in conjunction with the drawings described below, wherein like reference numerals are used throughout the several drawings to refer to similar components. It is noted that, for purposes of illustrative clarity, certain elements in the drawings may not be drawn to scale. Specific instances of an item may be referred to with a numeral and a second numeral following a dash (e.g., light fixtures 200-1, light fixtures 200-2, etc.) while numerals without a dash refer to any such item (e.g., light fixtures 200). In instances where multiple instances of an item are shown, only some of the instances may be labeled, for clarity of illustration.

The present disclosure describes user-friendly systems and methods for commissioning installations of light fixtures for controlling their later use, such that, for example, patterns of lighting variation can progress across the groups of light fixtures in a smooth or natural manner. As used herein, “commissioning” an installation means establishing an initial setup of a light fixture installation by creating, or loading data into, a database or data structure that defines at least location of, and optionally other attributes of, light fixtures in the installation. The tools and methods disclosed herein for commissioning allow typical users to build a graphical depiction of light fixture locations or other attributes, to register the attributes as a substitute for system level programming by a professional. The data structure can then be used later by a controller of the light fixtures to coordinate lighting characteristics across the light fixtures. For example, in embodiments the controller could use position information to time signals to the individual light fixtures such that a pattern would appear to move across the light fixtures in sequence, instead of all at once or in random order. In these and in other embodiments, many other possibilities of using location and/or other attribute data stored in such a data structure are possible.

Embodiments herein provide new and useful functionality for commissioning an installation of multiple light fixtures by generating a data structure for the installation that contains information including at least position information, and possibly orientation, fixture type and other aspects of light fixtures within the installation. The commissioning process is provided through user friendly and intuitive user interfaces. The data structure thus generated can be utilized for many types of system level operation.

In one important class of operations, it may be desired to operate the light fixtures in a sequence over time such that the information enables the sequence to flow smoothly from fixture to fixture, from the perspective of a viewer. For example, in an indoor setting that is set up to somewhat mimic an outdoor sky, a blue background color could provide traces of white in sequence across the light fixtures to simulate clouds passing by. Parking garages could use sequences to point drivers to general areas where parking spaces are available, or to a particular space. Commercial venues might use sequenced lighting in ceilings or floors to show a guest which way to go to get to a restaurant table, a customer service location or a retail item. Any type of venue could use sequenced lighting to show a guest which way to go to access an emergency exit. Any type of installation could use sequenced lighting to point maintenance workers toward a specific light fixture in need of repair or maintenance.

In another important class of operations, it may be desired to identify one or more light fixtures with attributes that are independent of the light fixtures' locations, types, orientations and the like. For example, a user-defined group may be identified for later use in selecting the user-defined group for operation at selected or scheduled times, as designated emergency lighting, and the like.

Existing groups of light fixtures that are capable of displaying such patterns, identification by stored attributes and the like are typically custom installations that are set up or commissioned by experts from a construction or architectural firm, or from a lighting company.

Embodiments herein recognize that, especially with the emerging use of light emitting diode (LED) light sources for general lighting, groups of light fixtures that are capable of displaying light variation patterns, and other modes of use, will become more commonplace, and that simplified, user friendly and cost effective systems and methods for commissioning such groups are needed. Simultaneously, computer literacy levels are rising among the general public, further lowering barriers to acceptance of systems that require user involvement to accomplish tasks like those discussed further below. The systems and methods for commissioning systems of multiple light fixtures herein are intuitive and easy to use, and advantageously permit not only initial system setup but further adjustments to systems already in place. Certain embodiments import information from computer aided design (CAD) files, to facilitate commissioning of complex lighting systems without tedious re-entry of existing information about light fixtures themselves and/or the edifice with which they are being associated. Some embodiments accommodate temporary or trial arrangements of light fixtures, and modifications to such arrangements, such that an arrangement can be commissioned and observed, and later adjusted. Some embodiments operate through hardwired connections among a controller and light fixtures, while other embodiments employ wireless technology to communicate commands to the light fixtures or to receive information from the light fixtures.

Certain light fixtures (sometimes called lighting modules herein) that may be particularly conducive to such control systems and methods are disclosed in U.S. patent application Ser. Nos. 13/866,971 and 13/866,939, and International Patent Application No. PCT/US2013/059306 (the “Applications”), the entirety of each of which is incorporated herein by reference for all purposes. The modules disclosed in the Applications are discussed herein to help demonstrate operation of the new control systems and methods.

The Applications disclose embodiments of wall-recessed indirect ambient lighting modules that can control task lighting and/or accent lighting separately and/or dynamically.

These lighting modules may, for example, bring an outdoor connection to interior environments where access to daylight may be limited (e.g., interior offices, cafeterias, hospitals, building core, etc.). Certain of these modules can provide soft, ambient illumination while also providing visual cues to suggest various environments. These environments include, but are not limited to, the penetration of daylight (akin to a portal to the outdoors).

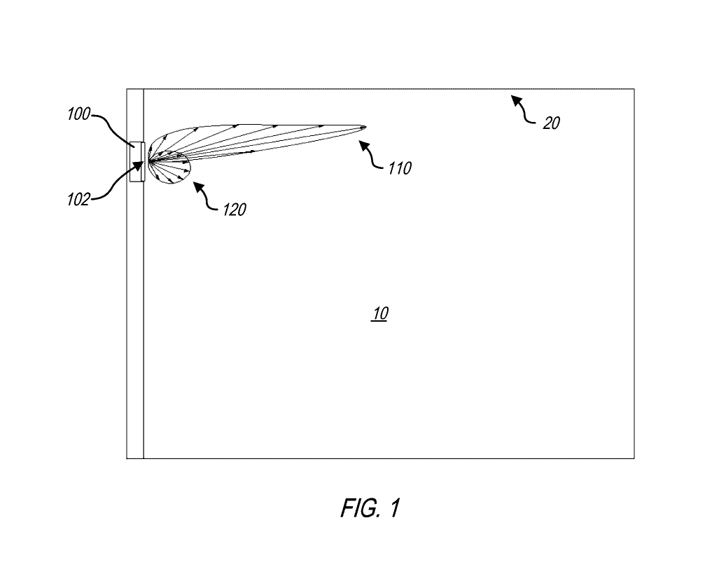

As described in the Applications, the lighting modules may include separate banks of light sources that can be powered individually to serve two or more discrete functions. An example is shown in FIG. 1, which illustrates a room 10 lit by illumination components of a lighting module 100. Some illumination components of lighting module 100 may, for example, incorporate high power “white” light emitting diodes (LEDs) to provide general lighting for the space being illuminated. These illumination components may provide a constant or a tunable “white” capability, or white point adjustment throughout a considerable correlated color temperature (CCT) range, warm to cool. It will be understood that general lighting is often advantageously “white” as perceived by humans, but other chromaticities of general lighting or lighting with specific requirements are also contemplated herein. The illumination components may cast light deeply into room 10, as suggested by polar plot 110; such light is distributed over a ceiling surface 20 of room 10, where it is reflected diffusely into room 10. In this way, room 10 is indirectly lit via the ceiling from a recessed wall location, as though light were penetrating the space from a sun position low on the horizon. The “white” LEDs may be positioned low in an aperture 102 of lighting module 100, and aperture 102 may be positioned high on the wall to eliminate direct view of the LEDs, and glare, entirely.

An accent component of lighting module 100 uses one or more LEDs that may emit colored light, or light with tunable color characteristics (e.g., red-green-blue (RGB) LEDs) to fill aperture 102 with a desired ambiance or appearance, such as, but not limited to, desired colors or visual effects that simulate desired scenes, such as an illusion of the sky as would be seen through a window. Light from the accent component emits throughout room 10, as suggested by polar plot 120 (polar plot 120 is not meant to suggest a specific point of light origin within aperture 102, but rather the far field characteristic of light spreading from any given part of aperture 102). The accent component generally emits light at a much lower intensity than the illumination component, as suggested by the relative sizes of polar plots 110 and 120. In this way, lighting module 100 may simulate effects such as sunlight (and others), without their drawbacks (e.g., the harsh glare associated with direct sunlight). In one embodiment, two banks of RGB LEDs are provided in the module—one at the top and one at the bottom—so that, operating as the accent component, they collectively define the look of the aperture, and may provide effects such as gradients across the aperture, but do not otherwise impact the general illumination in room 10 as provided by the “white” LEDs of the illumination component.

Each individual lighting module 100, or collection of such modules, can be programmed and/or coordinated (such as to emulate the outdoors and/or simulate the passage of time, e.g., clouds passing in the sky), as discussed below. However, by no means are the control systems and methods disclosed herein intended to be limited for use only with such light fixtures or lighting modules. For example, other lighting systems that can be commissioned utilizing the techniques herein may include numbers of light fixtures of any type (or of multiple types) in installations where it may be desired to operate the light fixtures in sequence or according to user-defined attributes of the light fixtures. Applications for such groups of light fixtures include almost any and all indoor or outdoor environments where light fixtures are typically installed: homes, offices, retail spaces, dining, entertainment and sporting venues, and parking lots or garages, to name but a few.

Embodiments herein relate to ways by which to permit a user easily and intuitively to control various aspects of light emitted from one or more lighting modules such as, but not limited to, the lighting modules disclosed in the Applications. In some embodiments, the modules are operable from a variety of means (wall switch, iPad/iPhone, Desktop computer, etc.). Several “canned” scenes, layouts or configurations can be provided for the user to choose from, but the appearance of the lighting modules can also easily be customized by the user.

Disclosed herein are embodiments of hardware and software interfaces that enable a user to communicate and control desired lighting aesthetics and to register locations of lighting modules with respect to one another in a light fixture data structure. The light fixture data structure is then utilized to prepare commands to the lighting modules during use, for example to coordinate such commands so that lighting and other effects are provided by the correct lighting modules in the correct order. Exemplary presentations of embodiments of such an interfaces are contained herein; however, these presentations are merely illustrative. Embodiments are not limited to the content and appearance of the illustrations herein. The interfaces may be implemented within various types of computer environments and/or operating systems, e.g., MAC (PC), Windows (PC), IOS, and Android versions.

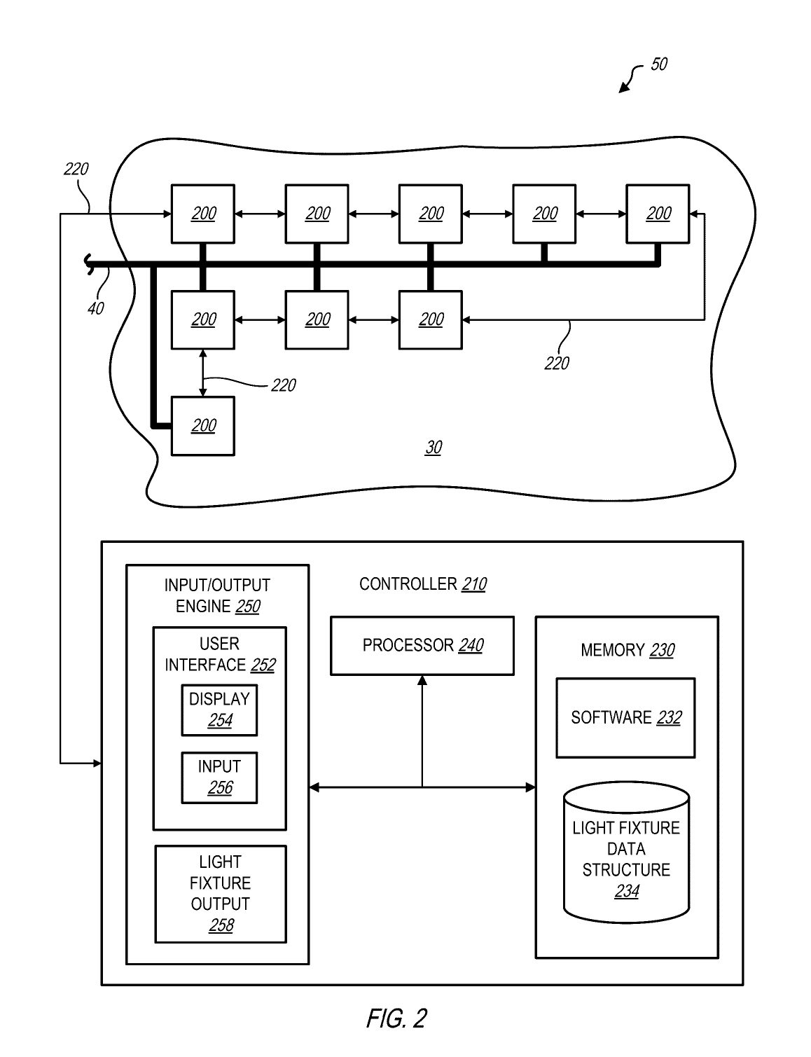

FIG. 2 is a generalized, schematic system diagram that illustrates a lighting system 50, including an installation of light fixtures 200 within a space 30, and a controller 210 configured for both configuring and controlling light fixtures 200. Lighting system 50 includes a group of light fixtures 200 that are installed within space 30. Space 30 may be, for example, a surface such as an indoor or outdoor wall, ceiling, partition, or the like, or a combination of such surfaces, in a room of a home or of any other type of edifice. Also, although represented in a two-dimensional form in FIG. 2 and other drawings herein, it is understood that space 30 may be three-dimensional, and that appropriate visualization techniques may be utilized to provide representations of space 30 (for example, in user interface displays, such as discussed further herein). Nine light fixtures 200 are shown in a particular arrangement in FIG. 2, but it should be understood that this number and arrangement are exemplary only; lighting systems 50 may include anywhere from two to any higher number of light fixtures, and the light fixtures may be arranged in any two- or three-dimensional manner. External power 40 (heavy lines in FIG. 2) is routed to each of light fixtures 200.

Controller 210 exchanges information 220 (lighter arrows in FIG. 2) with light fixtures 200; information 220 may be exchanged with light fixtures 200 through wires or through wireless communications, as discussed further below. FIG. 2 suggests a serial arrangement in which information 220 is sent serially to a first one of the light fixtures 200, from the first fixture 200 to the second one, and so on until all of the light fixtures receive information 220. Serial arrangements are possible but are not the only arrangements for providing information 220 to and from light fixtures 200; other ways of sending information 220 to all light fixtures are also possible and are discussed below. Thus, the arrows showing information 220 being exchanged among light fixtures 200 and only a first one of light fixtures 200 exchanging information 220 with controller 210 should be considered as illustrative but not limiting. Information 220 may be commands originating from controller 210 and/or response information from light fixtures 200.

Controller 210 may communicate information 220 via wired electrical connections or wirelessly, as discussed further below. Embodiments of controller 210 may be, at least in part, physically separable from space 30 where light fixtures 200 are installed, enabling a single controller 210 to commission more than one installation of light fixtures 200. Versions of controller 210 that connect wirelessly with light fixtures 200 are not physically coupled in the first place, and those versions that connect via wires can be provided with connectors that allow convenient disconnection. This enables owners or builders to purchase (or rent, borrow from a manufacturer, etc.) a single controller 210 instead of multiple controllers, and for the controller(s) to be kept out of the way after installation, instead of always being tied to the light fixtures. However, some embodiments herein permanently connect controller 210 with its associated light fixtures 200. In any case, at least some portion of controller 210 remains able to communicate via wired connections or wirelessly after installation, to operate light fixtures 200 according to stored position information and/or any other information captured during the commissioning process.

Controller 210 is shown as including the following components. A memory 230 is used to retain information such as software 232, a light fixture data structure 234, and optionally other information needed by controller 210 and/or generated by interaction of controller 210 with light fixtures 200 and/or one or more user(s). Memory 230 typically includes at least some non-transitory memory (e.g., nonvolatile memory, such as Flash memory) to retain software 232 and data structure 234 while controller 210 is powered down; however memory 230 may also include fast working memory such as RAM (Random Access Memory) that does not retain information when powered down. A processor 240 executes software 232, and exchanges information with memory 230 and input/output engine 250. Memory 230, processor 240 and input/output engine 250 are communicatively coupled with one another; one or more of memory 230, processor 240 and at least parts of input/output engine 250 may coexist within a single computer chip or processor card. Information exchange among memory 230, processor 240 and input/output engine 250 are shown with arrows in FIG. 2; internal power connections, more specific information paths among these components, their subcomponents, and the like are not shown in FIG. 2 for clarity of illustration.

Controller 210 is typically built as special-purpose hardware, and may include an inexpensive microcontroller as processor 240, enough memory 230 to store software 232 and data structure 234, and so forth. In one particular embodiment, controller 210 includes a MitySOM-335 processor card available from Critical Link, LLC as Model No. 3352-HX-X47-RI, featuring a Texas Instruments AM3352 processor, 1 GB of Flash memory, 256 MB of RAM, two 10/100/1000 Mbps EMACs to facilitate Ethernet connections, six UARTs that can be used to facilitate Bluetooth and DMX functionality (DMX being discussed below), a touch screen controller, two USB ports, and other features. This particular embodiment of controller 210 is packaged within a small housing measuring less than 5 inches per side. It is anticipated that other embodiments of controller 210, using features chosen for adequate functionality and low cost, could be built with housings of less than 5×2×1 inches in size, at a total cost of about $50 or less per controller.

Thus, controller 210 is not a general purpose computer system. It is contemplated that not all of the components shown in FIG. 2 and noted above will be present in every embodiment of a controller 210, while other components may also be present. Furthermore, the exact form of controller 210 may vary and may not be integral. In certain embodiments, controller 210 may be housed in a single, physical housing located in proximity to space 30, or may be housed within one of light fixtures 200. In other embodiments, components of controller 210 may be distributed among two or more physical locations. Controller 210 may be packaged and sold as part of a kit that includes some number of light fixtures 200, or may be sold as a separate product, including sale to distributors as a rental or loaner unit that can be temporarily provided to customers at a time of commissioning.

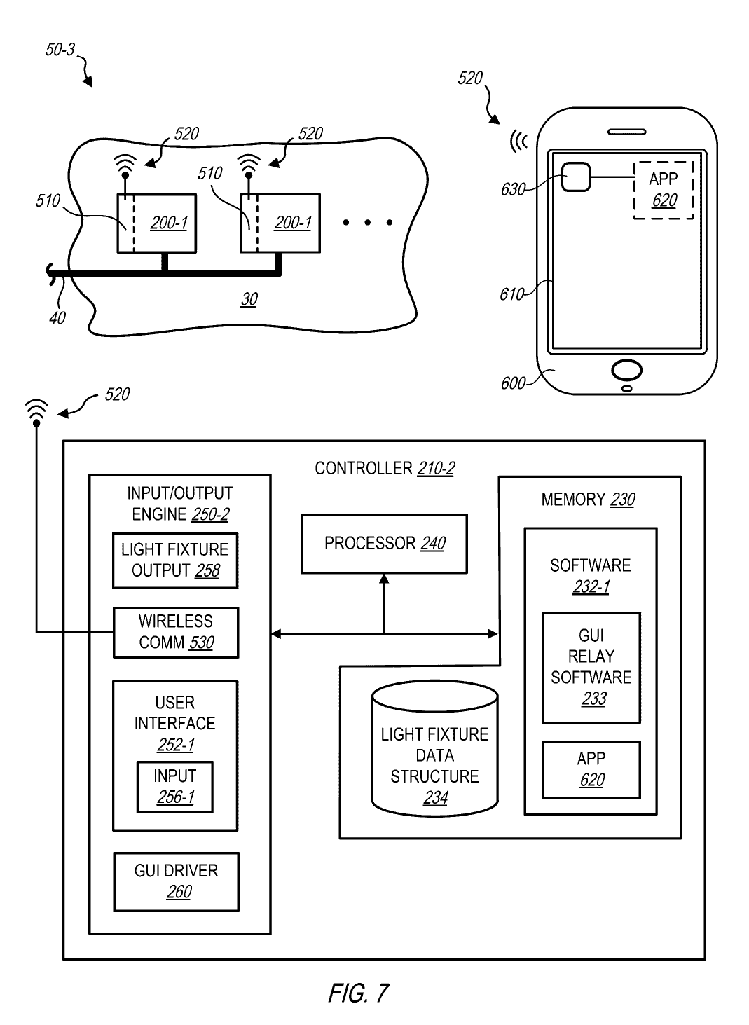

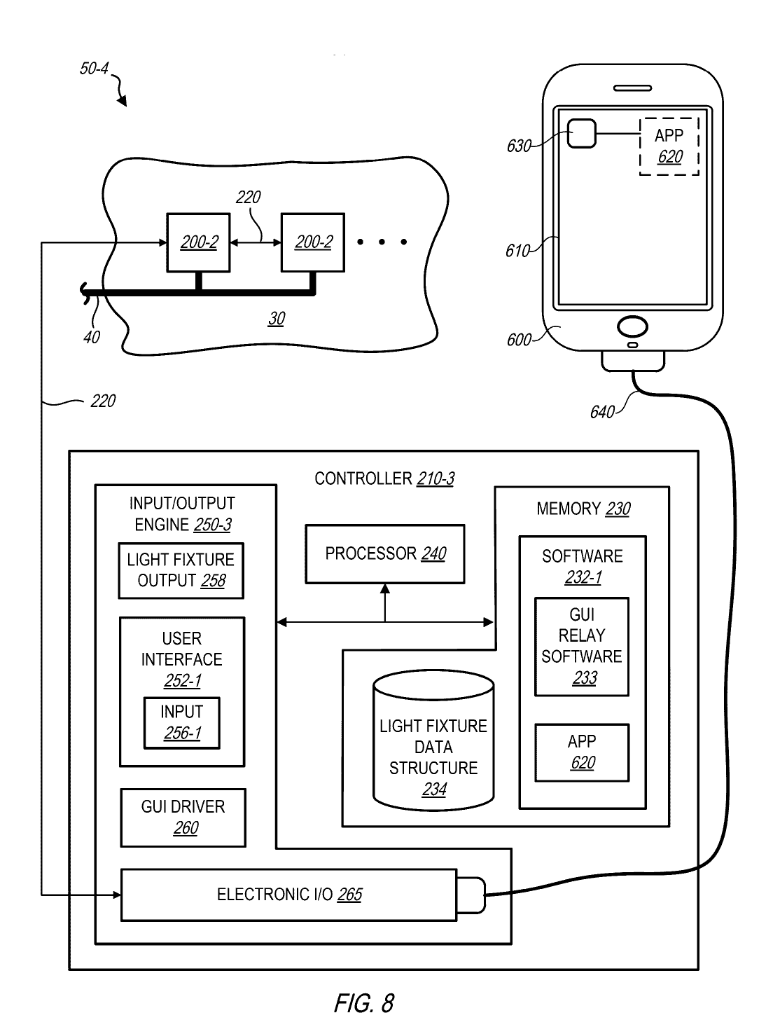

In certain embodiments, input/output engine 250 includes a user interface 252 that includes at least a display 254 and an input device 256 (other embodiments may shift part or all of user interface functionality to another device, see FIGS. 7 and 8). Display 254 and input device 256 may be provided in many possible forms. For example, display 254 may be a display on a physical housing of controller 210, or it may be a display on a remote device, such as a remote touch screen display, connected by wired or wireless connections with other components of controller 210. Similarly, input device 256 may be literally one or more switches (or buttons, mouse or joystick, etc.) on a physical housing of controller 210, may be a remotely located touch screen, or other device capable of encoding information from a user and transmitting the information to processor 240. Display 254 and input device 256 may be physically integrated with one another (e.g., as a touch screen or other control box) or may be separate from one another. Input/output engine 250 also includes light fixture output 258, which issues information 220 to light fixtures 200.

In certain embodiments, light fixture output 258 issues information 220 according to the DMX512 standard (referred to herein simply as “DMX”). In these embodiments, each particular light fixture 200 has one or more unique addresses within the DMX address space, and reacts to information 220 that includes the address(es) of that particular light fixture 200. For example, when a light fixture 200 has multiple light sources that can act separately from one another, each of the light sources would have its own DMX address.

Also, in particular embodiments, certain commands from controller 210 to light fixtures 200 result in responses according to the related DMX/RDM standard, which defines two-way communications between a controller and the light fixtures. A typical use of the DMX/RDM capability is for controller 210 to issue an electronic “discovery” command to any available light fixtures 200, requesting that they identify themselves and/or provide other information in response to the electronic command. Light fixtures 200 that are DMX/RDM capable provide information in response. A minimal response is a DMX address only; controller 210 can determine from the number of unique DMX addresses provided, a count of how many light fixtures are in the installation. Other information can also be provided through DMX/RDM responses, for example, a light fixture 200 may respond with its DMX address, and optionally with its light fixture type, dimensions, wattage and/or other characteristics. Any such responses or other data generated by any of the light fixtures 200 is passed back to controller 210 as information 220. In this way controller 210 generates at least initial information about how many light fixtures 200 are present, and what their DMX addresses are, and optionally other information as well.

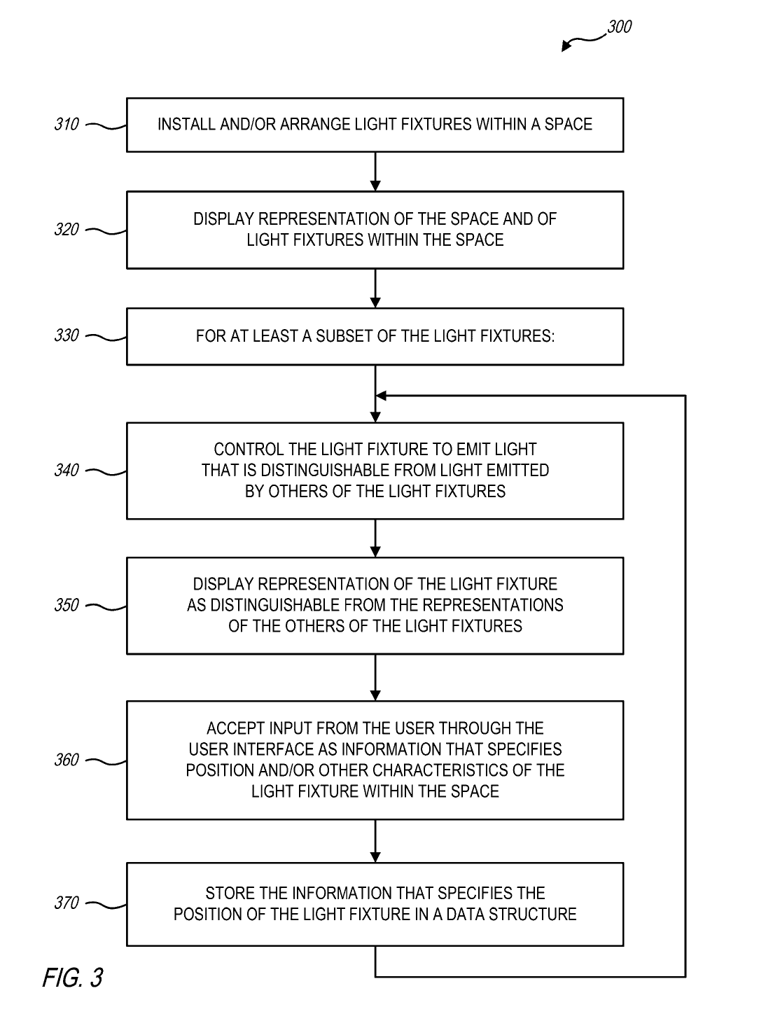

In embodiments, a lighting installation (e.g., lighting system 50) is commissioned using an intuitive, user friendly method 300, FIG. 3. A general case of method 300 is provided, followed by discussion of certain optional features of lighting installations and methods in accord with embodiments. It will be appreciated that the steps listed in method 300 need not be performed in the order listed, in some cases. Also, other variations and possibilities will be evident to one skilled in the art upon reading and comprehending the present disclosure. Further, because various physical devices (for example, a controller, a user device, and/or a server accessed over the Internet), may perform various ones of the steps of method 300, the recitation of the steps of method 300 should be considered, as appropriate, to mean causing or controlling the referenced activity to occur. That is, a single entity might provide certain hardware that performs certain steps of method 300, while other steps are performed by devices (e.g., a user device) not belonging to the entity, but operating under control of the software provided by the entity.

Step 310 of method 300 installs and/or arranges light fixtures within a space. Step 310 is an optional or preparatory step, and refers to arrangement and/or installation of actual, physical light fixtures within an actual, physical space. An example of step 310 is installing light fixtures 200 within space 30, FIG. 2. Other examples of step 310 might be arranging light fixtures in trial or temporary locations so that they can be commissioned and observed in operation, with the possibility that they may later be moved. Step 310 includes arranging power to the light fixtures (e.g., external power 40, FIG. 2) and establishing control of the light fixtures by a controller (e.g., installing wired and/or wireless communications from controller 210 to pass information 220 to light fixtures 200, FIG. 2). Step 310 may optionally include controller 210 issuing a “discovery” command as information 220 to an initially unknown, but connected, set of light fixtures that can respond with identifying information (e.g., using the DMX/RDM protocol) so that the controller can identify the presence of, and one or more address(es) for, each available light fixture.

Step 320 displays a representation of the space and representations of light fixtures. An example of step 320 is displaying a representation of space 30, and light fixtures 200, within display 254 of controller 210, FIG. 2. The representation of the space may be abstract or realistic, according to the capabilities of the display used; for example it may be a simple grid, shown on a display device, that represents a wall in which light fixtures are located. In more complex embodiments, the display of the space may resemble the appearance of a wall, more than one wall, or other arrangement, and may be a representation of a two-dimensional (2D) or of a three-dimensional (3D) arrangement. The representation of the space may be generated by the controller without a priori assumptions (e.g., a featureless 2D grid) or may be imported from other CAD tools (e.g., a data structure from a CAD file that represents a building, or a portion thereof, possibly showing complex shapes, surface finishes and the like). Similarly, the representations of the light fixtures may be abstract or realistic, and may be simple representative icons, or items that resemble the light fixtures that they represent. The representations of the light fixtures advantageously include some identifying characteristic that allows a user to determine with certainty which light fixture representation corresponds with which physical light fixture, as discussed below in connection with step 340. The representations of the light fixtures may include ways of indicating customizable features of the light fixtures, orientation of the light fixtures, and the like. The representations of the light fixtures may be provided by the controller based on information previously provided to the controller, based on the light fixtures identifying themselves (e.g., using the DMX/RDM protocol as per above, although other methods of self-identification are possible) or based on the user identifying the available light fixtures.

Step 330 notes that the steps that follow, are performed for at least a subset of the light fixtures; steps 340 through 370 form a set of steps that are repeated for each light fixture identified in step 330. Examples of step 330 are controller 210 identifying one of light fixtures 200, FIG. 2, or a user identifying one of the representations of the light fixtures, as shown in display 254, and indicating the selection to controller 210 through input device 256. It is contemplated that one, some, or all of the light fixtures (and their corresponding representations) may be identified simultaneously, as discussed below. However, in embodiments, not every light fixture is so identified. For example, certain embodiments may identify some of the light fixtures in turn such that steps 340 through 370 may be performed on the light fixtures so identified, but a last one of the light fixtures may be identified by default such that step 340, at least, may not need to be performed to identify it. That is, it will not be necessary to identify the light fixture that is the last one available. Other embodiments may simply generate information that light fixtures belong to one of several groups, and when only light fixtures of one group remain, those light fixtures need not be the subject of steps 340 through 370.

For each light fixture, step 340 controls the light fixture to emit light that is distinguishable from light emitted by others of the light fixtures. An example of step 340 is controller 210 issuing a command as information 220 to the selected one of light fixtures 200, FIG. 2, to emit light of a color that is distinguishable from light emitted by all other light fixtures 200. Any mode of doing so is contemplated; in particular, a very useful and intuitive way of identifying many light fixtures and light fixture representations in parallel is to choose a unique color for each, provide commands that cause the light fixtures to emit light in the unique colors, and render the representations of the light fixtures in the user display with the same, unique colors. Identification by unique colors is particularly well adapted to commissioning lighting modules 100, FIG. 1, in which light from the accent component is provided by banks of RGB LEDs that can provide light tuned to many different colors. The unique color mode of identification also enables many light fixtures and their representations to be simultaneously identifiable, as opposed to identifying one at a time. However, other ways of identifying light fixtures individually are also possible; for example a currently selected one of the light fixtures may be commanded to emit bright light while all other light fixtures of the installation are commanded to emit dim light (or no light); a currently selected one of the light fixtures could provide a pulsating light, and so on.

For the light fixture selected in step 330 and controlled in step 340, step 350 displays the representation of the selected light fixture as distinguishable from the representations of the others of the light fixtures. An example of step 350 is rendering a representation of the selected light fixture in display 254, FIG. 2, with the same color as is being emitted by the selected light fixture 200, as noted above. Other examples of step 350 might include overlaying or otherwise associating text with the representation of the selected light fixture, or providing a representation of the light fixture with a unique visual highlight.

Step 360 accepts input from a user, through a user interface, as information that specifies position and/or other characteristics of the selected light fixture. The information could be position and/or orientation of the selected light fixture, or other user preferences related to the selected light fixture. An example of step 360 is controller 210, FIG. 2, accepting input from a user through input device 256 that specifies position and/or other characteristics of light fixtures. The input is advantageously provided from a graphical user interface (GUI) that provides a display to the user, indicating a characteristic such as position. The GUI allows the user to adjust the characteristic if needed, and eventually allows the user to indicate that the adjusted characteristic should be saved.

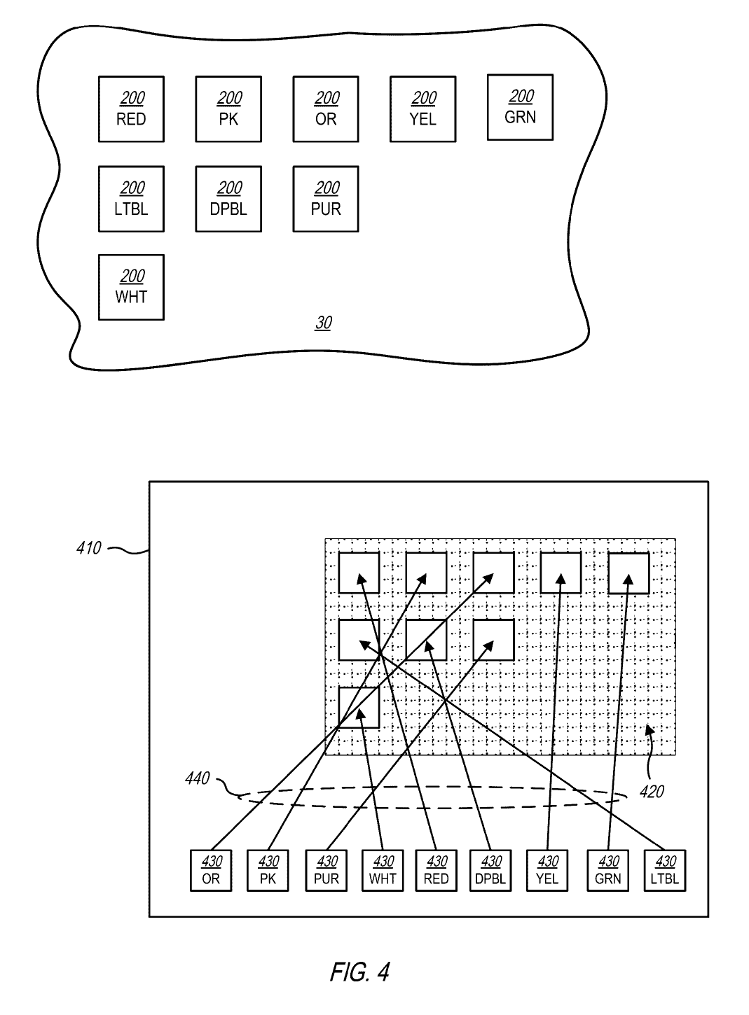

Departing briefly from the description of method 300, FIG. 4 provides an illustration relevant to an understanding of steps 340, 350 and 360 in the context of a controller that utilizes a graphical user interface (GUI) 410. GUI 410 may be implemented, for example, using a touch screen such as found on present day computers, tablets, mobile phones and other devices, wherein a user typically touches the screen with a finger to select and “move” objects, but it is contemplated that other embodiments involving displays that show the action of pointing devices such as a computer mouse, joystick, trackball or the like could be used. Thus, GUI 410 may include certain functionality of both display 254 and input device 256, FIG. 2. The user is in a position to see space 30, where light fixtures 200 have been installed as illustrated. The controller activates each light fixture 200 to display a different color; for example the exemplary colors of red, pink (pk), orange (or), yellow (yel), green (grn), light blue (ltbl), deep blue (dpbl), purple (pur) and white(wht) are shown, although of course any unique colors may be used. Within a display (e.g., display 254) associated with GUI 410, the controller provides a grid 420 as an initially blank representation of space 30, and a set of light fixture representations 430. The user can then select and move representations 430 into appropriate positions within grid 420, thus providing input through the user interface as information that specifies a position of each of the light fixtures 200 within space 30. The positions represented within grid 420 may, in embodiments, be relative or absolute positions. In certain discussions that follow, references to items being “shown in the GUI” should be understood to mean items being shown in a display, such as display 254, that forms part of a GUI, and actions being performed “by the GUI” should be understood to mean actions performed by the controller and/or a user device, in connection with a display and an input device that form part of a GUI.

Grid 420 may be of any grid spacing, but it should be clear to those skilled in the computer and graphical user interface arts that tradeoffs may exist among grid spacing, accuracy of indicating light fixture positions, memory requirements, and possibly other aspects. In certain embodiments, the finer the grid, the more accurately fixture positions can be represented, but the more memory may be required to retain high precision grid addresses. Human dexterity may also factor into the choice of grid spacing; for example, it may be advantageous to provide a relatively coarse grid and a GUI that “snaps” objects into nearby available grid locations, to avoid users becoming frustrated over inability to provide fine position control using a touch screen. Embodiments may therefore use very fine grid spacings so as to locate lighting fixtures very accurately with respect to one another, or coarse grid spacings to minimize data storage requirements and/or to simplify a user's interaction during the commissioning process (by providing fewer, easier to specify choices for light fixture locations). Many lighting installations require only a coarse grid spacing such that representations positioned therein simply indicate gross location of light fixtures relative to one another. In certain embodiments, grid 420 is reduced to a set of predefined light fixture locations, such that the user's choices during commissioning are limited to identifying and indicating which light fixture is in which predefined light fixture location. FIG. 4 illustrates one particular grid spacing that is about one third the dimension of each of the representations 430 used in the example, with grid spacings between locations of representations 430, as determined by the user in the example, of two grid units.

Initially the controller does not “know” where each light fixture 200 is; that is, the controller may have one or more electronic address(es) for each light fixture 200, but no position information for the light fixtures. Therefore the controller initially assigns arbitrary colors to light fixture representations 430 according to the number of discovered or activated light fixtures 200. Therefore, light fixture representations 430-1 through 430-9 are initially provided with random color assignments that correspond to the colors being displayed by light fixtures 200. The user selects each light fixture representation 430 that is available and moves it (e.g., “drags and drops” it) to a location in grid 420. The controller thus receives input from the user as information that specifies a position of each of the light fixtures within the space, by determining registration of each light fixture representation 430 with the representation of the space (grid 420). As noted above, GUI 410 may assist by “snapping” representations 430 into nearest available locations of grid 420. The user may move the representations 430 in any order, and may move any of representations 430 temporarily and go back and move them again. Each time a movement of a representation 430 onto or within grid 420 occurs, the controller keeps track of the resulting configuration, according to which particular representation is moved and where. Thus, the user simply moves representations 430 around until the pattern shown on GUI 410 matches what the user sees in space 30. This is why displaying unique colors in the light fixtures, and providing representations with colors that match the displayed colors, is especially convenient.

Setting up a grid with light fixture representations 430 can also be done by having the user select one representation 430 at a time (e.g., by tapping or clicking on the representation 430 in the display of GUI 410), whereupon controller 210 recognizes the selected representation 430 and generates a unique light intensity or blinking pattern in the corresponding physical light fixture 200. The user would then observe the physical light fixture 200 and move the selected representation 430 to a grid location that corresponds to the position of the light fixture 200. Alternatively, controller 210 can determine an order in which light fixtures 200 are uniquely identified, so that the user can move each corresponding representation 430 to indicate where each light fixture 200 is, then indicate to the controller 210 that the next light fixture 200 should be identified.

Returning to FIG. 3, once the user is satisfied that the position (and/or other characteristics) of a light fixture is accurately represented in the display, the controller stores the information that specifies at least position information, in a data structure that is particular to the installation. Method 300 optionally, returns to step 340 as needed until all light fixtures have been identified and displayed, and the desired information has been received through the user interface to specify position and/or other characteristics of the light fixtures.

The data structure thus generated or modified can subsequently be used to operate the light fixtures, taking the position (and/or orientation, or other attribute) information into account. Several embodiments wherein light fixtures are operated with known position information are discussed below.

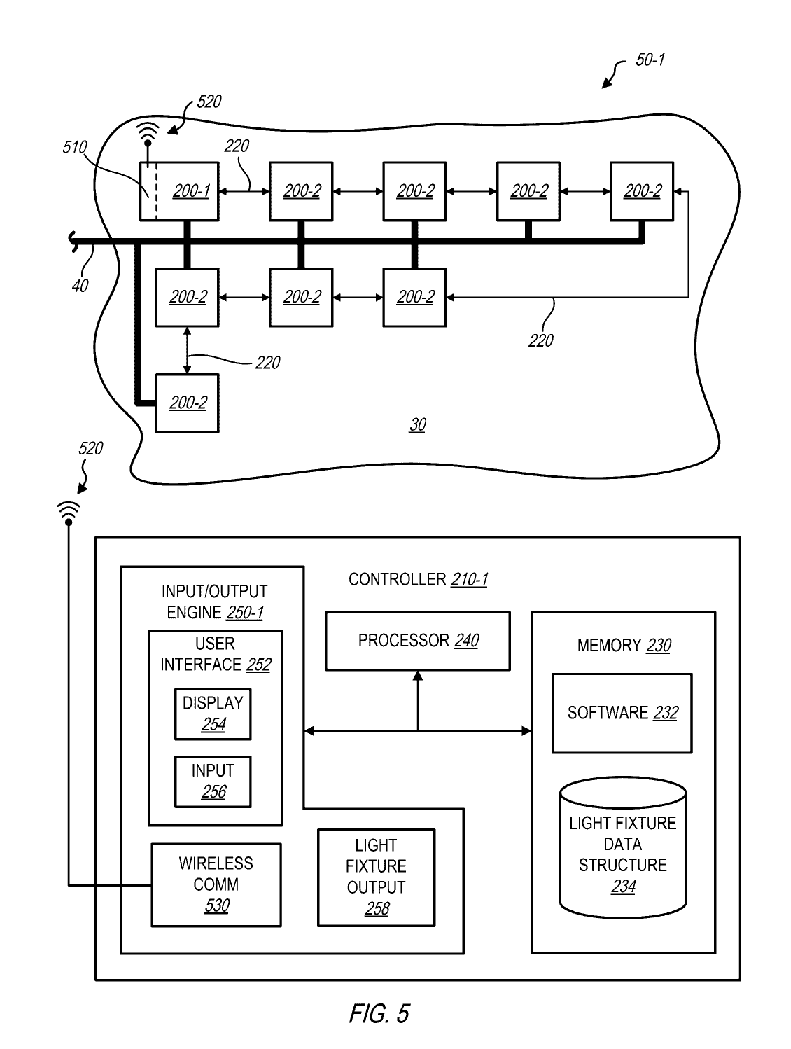

The discussion of FIG. 2 was based on the light fixture installation and the controller being connected primarily through wiring, but that need not be the case. Certain embodiments make certain connections through wireless and/or optical protocols. For example, FIG. 5 schematically illustrates a lighting system 50-1 as a special case of lighting system 50, FIG. 2. Lighting system 50-1 includes an installation of light fixtures 200-1, 200-2 within a space 30, and a controller 210-1 configured for both configuring and controlling light fixtures 200-1, 200-2. Controller 210-1 may be an inexpensive, special purpose unit that may be built and sold with light fixtures 200-1, 200-2 or separately therefrom.

Controller 210-1 connects wirelessly with light fixture 200-1 of lighting system 50-1, for example over a WiFi or Bluetooth link, using a wireless communication module 530 that generates wireless signals 520. Light fixture 200-1 includes a wireless communication device 510 capable of at least receiving and generating an electrical version of wireless signals 520 from controller 210-1. The electrical version of the wireless signals 520 corresponds with information 220 (see FIG. 2). Having generated information 220, light fixture 200-1 responds appropriately to any commands directed to its particular address, and passes on information 220 to the remaining fixtures 200-2. Each light fixture 200-2 acts on commands addressed to it, as well as passing information 220 to the next light fixture 200-2 in sequence; thus information 220 is sent serially from first fixture 200-1 to the first fixture 200-2, on to the second fixture 200-2, and so on until all of the light fixtures receive information 220. When any of light fixtures 200-1, 200-2 are configured to provide responses (e.g., according to DMX/RDM), wireless communication device 510 of light fixture 200-1 is a transceiver, and any responses or other data generated by any of the light fixtures 200-1, 200-2 is passed back to light fixture 200-1 as information 220, and light fixture 200-1 sends the responses back via signals 520 to controller 210-1.

The configuration illustrated in FIG. 5 is advantageous for commissioning installations that include a number of light fixtures 200-1, 200-2 relatively close to one another, such that it is cost effective to run wires among light fixtures 200-1, 200-2 to pass information 220 thereamong, relying on light fixture 200-1 to provide wireless connectivity to controller 210-1.

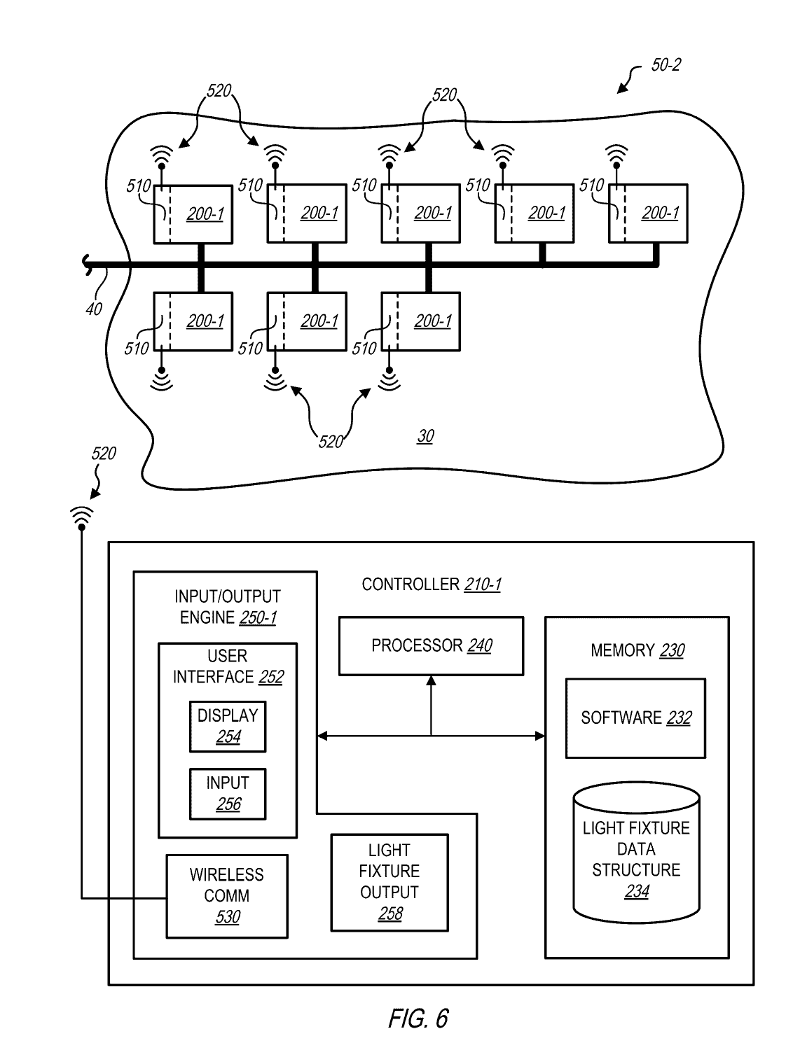

FIG. 6 schematically illustrates a lighting system 50-2 that wirelessly connects controller 210-1 with all light fixtures associated with an installation. Lighting system 50-2 includes an installation wherein all light fixtures are light fixtures 200-1, each such light fixture including a respective appropriate wireless communication device 510 (e.g., a receiver or transceiver). Light fixtures 200-1 are installed within a space 30, and a controller 210-1 (e.g., the same controller 210-1 as shown in FIG. 5) is configured for both configuring and controlling light fixtures 200-1. Again, controller 210-1 may be an inexpensive, special purpose unit that may be built and sold with light fixtures 200-1 or separately therefrom.

Controller 210-1 connects wirelessly with all light fixtures 200-1 of lighting system 50-2, for example over respective WiFi or Bluetooth links, using wireless communication module 530 to generate wireless signals 520. The arrangement shown in FIG. 6 connects each light fixture 200-1 directly with controller 210-1 such that information need not be exchanged directly between light fixtures.

The configuration illustrated in FIG. 6 is advantageous for commissioning installations in which it may be physically difficult and/or cost prohibitive to run wires among light fixtures 200-1, 200-2 to pass information 220 thereamong, as in FIG. 5. This might include, for example, very large installations with significant distances between light fixtures, or system level installations that are being retrofitted to existing light fixture locations having power 40 routed thereto, but lacking practical access to run additional wires among the light fixtures. However, like lighting system 50-1, lighting system 50-2 also advantageously enables physically separating controller 210-1 from the light fixtures 200-1 such that a single controller 210-1 can be utilized to commission more than one installation of light fixtures 200-1, 200-2.

FIG. 7 schematically illustrates a lighting system 50-3 that wirelessly connects a controller 210-2 and a user device 600 (e.g., a smartphone or tablet computer) with multiple light fixtures 200-1. Lighting system 50-3 includes an installation similar to that illustrated in FIG. 6, shown schematically with two representative light fixtures 200-1, but any number of light fixtures 200-1 may be present. Light fixtures 200-1 are installed within space 30. Controller 210-2 may be an inexpensive, special purpose unit that may be packaged and sold with light fixtures 200-1, or may be sold separately.

Similar to the case illustrated in FIG. 6, controller 210-2 is illustrated as connecting wirelessly with light fixtures 200-1 of lighting system 50-3, for example over respective WiFi or Bluetooth links, using wireless communication module 530 to generate wireless signals 520. (In similar embodiments, some or all of the connections illustrated as wireless signals 520 are replaced with wired connections; see FIG. 8.) In FIG. 7, controller 210-2 communicates wirelessly with user device 600 using wireless signals 520; the wireless protocol used to communicate between controller 210-2 and user device 600 may or may not be the same wireless protocol used to communicate between controller 210-2 and light fixtures 200-1. Also in FIG. 7, controller 210-2 includes an optional user interface 252-1 that is similar to that illustrated in FIGS. 5 and 6, but may be less sophisticated, supporting for example only input devices 256-1 in the form of simple on/off switches. Other user interface responsibilities, such as the feature of displaying a grid during commissioning, are provided by user device 600, for example by running an app 620, described below. In related embodiments, input/output engine 250-2 does not include user interface 252-1 at all.

For user device 600 to provide features such as the GUI function, either requires controller 210-2 to manage the GUI function remotely, or more commonly, for user device 600 to provide the GUI functionality through software such as app 620, such that user device 600 assumes control over the commissioning process. In the latter case, user device 600 manages all interaction with the user, tells controller 210-2 how to operate light fixtures within lighting system 50-3 and communicates final position information back to controller 210-2 when the process is complete.

For example, in embodiments wherein controller 210-2 manages the GUI function, software 232-1 of controller 210-2 may include GUI relay software 233. When executed by processor 240, GUI relay software 233 provides explicit direction to user device 600, including what to display to the user, and how to display it. Equivalently, instead of processor 240 managing this function directly, input/output engine 250-2 can include a GUI driver 260 implemented in firmware that provides appropriate translation for information being communicated to and from user device 600. Both GUI relay software 233 and GUI driver 260 are shown in FIG. 7, although in certain cases only one or neither of these features may be present.

In both of the embodiments discussed immediately above, it is immaterial whether controller 210-2 or user device 600 could be said to “manage” the commissioning process. In some embodiments, controller 210-2 essentially acts as the manager, and user device 600 is merely employed as a convenient user interface tool; in other embodiments, user device 600 running an app 620 (see below) essentially acts as the manager, while controller 210-2 simply interfaces with light fixtures 200 and stores the data captured during the commissioning process for later use.

In other embodiments, user device 600, executing app 620 (see below) is the manager of the commissioning process. In these embodiments, user device 600 essentially acts as the manager of the commissioning process, and relays commands to controller 210-2 as to how light fixtures 200-1, 200-2 are to be operated. For example, user device 600 may request that controller 210-2 provide address information for the installed light fixtures, receive the address information, tell controller 210-2 how to operate the light fixtures for purposes of identifying them to the user, and send the completed light fixture data structure 234 back to controller 210-2 when the process is complete.

User device 600 includes native input/output functionality for users, typically in the form of a GUI implemented via a touch screen 610 that can display information and accept user input in the form of finger taps, swipes and the like. A software application (generally called an “app” herein), 620 is stored in memory of user device 600, executed by a processor thereof and represented by an icon 630 shown in touch screen 610 of user device 600. App 620 may be coded, for example in HTML5, a markup language that is not necessarily platform specific; that is, it may allow for one version of code to run on a variety of operating system platforms such as iOS, PC and Android systems. App 620 is usually downloaded from the Internet, but can also be loaded onto user device 600 in other ways, as discussed below; for this reason, app 620 is also illustrated as stored in memory 230 of controller 210-2. In the embodiment illustrated in FIG. 7, similar to the embodiments illustrated in FIGS. 5 and 6, controller 210-2 continues to handle communication with light fixtures 200-1, but unlike the FIGS. 5 and 6 embodiments, the FIG. 7 embodiment uses user device 600 to handle the user interface.

This arrangement simplifies the requirements for, and thus the expense of building, controller 210-2. Specifically, as compared to controller 210-1 illustrated in FIGS. 5 and 6, controller 210-2 may retain simple user input functions, but can offload more complex user interface functionality required for the commissioning process, to user device 600. App 620 provides custom functionality for user device 600 to use the native GUI functionality of user device 600 to interface with a user, and to exchange information with controller 210-2 and possibly directly with light fixtures 200-1. Thus, when app 620 runs within user device 600, a user can see a display on touch screen 610 that is similar to GUI 410 discussed in connection with FIG. 4, such that the user can provide information about light fixture positions and/or other attributes. The information thus generated is communicated to controller 210-2, which stores the information in light fixture data structure 234. One skilled in the art, upon reading and understanding this description, will understand that controller 210-2 and user device 600 executing app 620 can, between them, perform method 300 (FIG. 3) and variations upon method 300 as described herein. In embodiments, transmissions between app 620 running on user device 600, and controller 210-2 deliver JavaScript Object Notation (JSON) files; wireless communication module 530 and app 620 may use a remote procedure call (JSON-RPC) to send and receive the JSON files.

While FIG. 7 illustrates “all wireless” connections among controller 210-2, light fixtures 200-1 and user device 600, FIG. 8 illustrates an “all wired” embodiment that can provide similar or identical system level functionality over wired connections. A controller 210-3 includes features that are similar to those of controller 210-2, but further includes an input/output engine 250-3 that features electronic input/output 265. Electronic input/output 265 may include hardwired connections and/or input/output ports such as universal serial bus (USB) ports, or Ethernet ports connectable with category 5 (CAT5) cable. In FIG. 8, light fixtures 200-2 installed within space 30 include wired connections with each other and back to electronic input/output 265. Similarly, user device 600 connects via a cable 640 to electronic input/output 265.

Other than the features that support wired instead of wireless connections, user device 600 and controller 210-3 illustrated in FIG. 8 have substantially the same capabilities as those illustrated in FIG. 7. It is contemplated, and will be understood by one skilled in the art upon reading and comprehending the present disclosure, that configurations falling between the “all wired” and “all wireless” embodiments shown are possible. That is, certain embodiments may utilize some wired connections and other wireless connections, without limitation, according to the requirements of a particular installation, to provide a richer user interface, to provide a less expensive controller, or for other reasons.

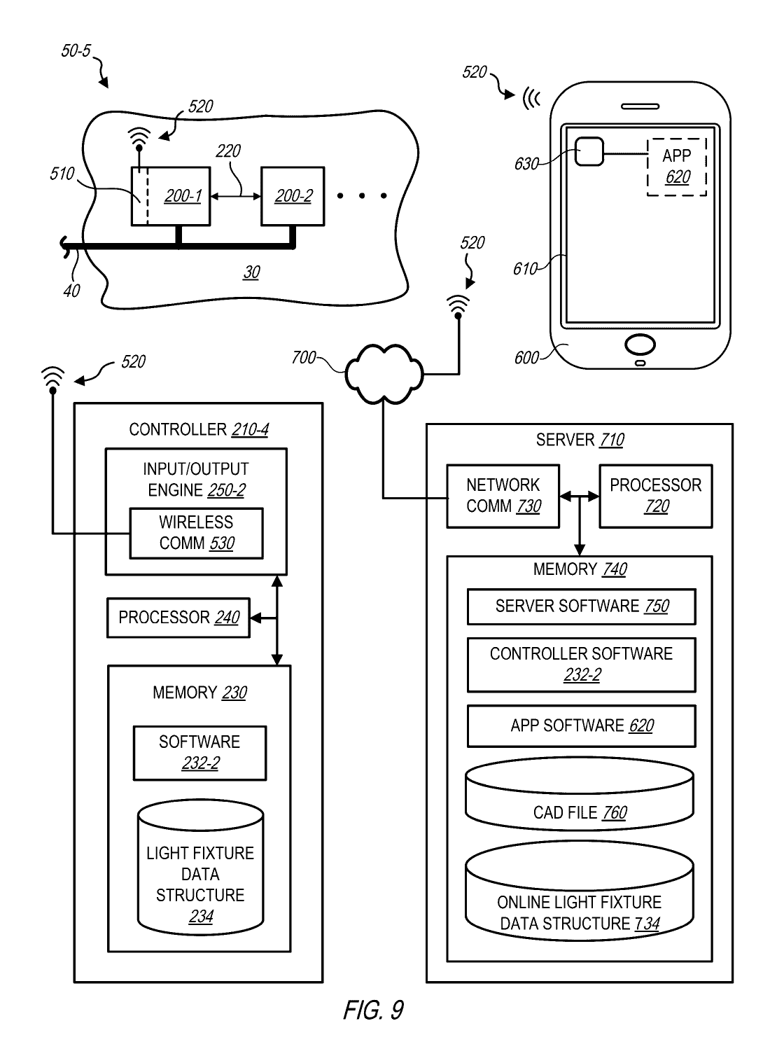

FIG. 9 illustrates a lighting system 50-5 that wirelessly connects a controller 210-4 and user device 600 with multiple light fixtures 200-1, 200-2, with access to software and/or data facilitated by connections to the Internet 700. Lighting system 50-5 includes an installation similar to that illustrated in FIG. 5, shown schematically with one light fixture 200-1 receiving wireless signals 520, and sending commands as information 220 over wired connections to further light fixtures 200-2. However, any configuration of light fixtures 200-1, 200-2 may be utilized, as discussed above, and may connect with controller 210-4 over wired or wireless connections. Light fixtures 200-1, 200-2 are installed within space 30. Controller 210-4 may be an inexpensive, special purpose unit that may be packaged and sold with light fixtures 200-1, or may be sold separately. Controller 210-4 is illustrated as including a processor 240, memory 230 storing at least software 232-2 and light fixture data structure 234, and input/output engine 250-2 including wireless communication module 530, although other software and/or hardware capabilities may be present. User device 600 runs app 620, represented within touch screen 610 by icon 630, as discussed above. Controller 210-4 and user device 600 are illustrated as connecting with one another and/or lighting system 50-5 through wireless signals 520, although in embodiments, certain connections thereamong may be wired connections, as discussed above.

A server 710 is connected with the Internet and hosts access to data and/or software. For example, server 710 is illustrated as having a processor 720 and memory 740, and connecting to Internet 700 using network communication module 730. Memory 740 is illustrated as storing server software 750 (e.g., software for hosting a web page), controller software 232-2, software of app 620, a CAD file 760, and an online light fixture data structure 734, although not all such software, database and/or data structure are present in every embodiment. User device 600 and/or controller 210-4 can access server 710 through a connection to the Internet, e.g., through a user's home network. In embodiments, connections to the home network may be made through wireless signals 520 (e.g., WiFi) as illustrated; other embodiments may utilize wired connections (e.g., a CATS cable connecting with a local network router).

The Internet-enabled functionality illustrated in FIG. 9 facilitates certain benefits for commissioning light fixture installations. For example, controller 210-4 may be built and sold with a starter software package that is merely complete enough to enable a connection to Internet 700 and/or user device 600, in the expectation that software 232-2 will be updated at the time of commissioning by connecting with server 710; similarly, app 620 can be downloaded to user device 600 from server 710. Existing software 232-2 and/or app 620 can be updated from server 710 if desired. Light fixtures 200 of new types can be introduced in the expectation that existing controllers 210-4 and/or apps 620 on user devices 600 can be updated with software to support commissioning of installations that include the new light fixtures 200. In embodiments, controller 210-4 can utilize software and memory capabilities of server 710 to facilitate a commissioning process. For example, a webpage running on server 710 can provide functionality that is not present within controller 210-4, including assembling and/or storing online light fixture data structure 734 during the commissioning process. In these embodiments, the completed online light fixture data structure 734 is typically downloaded to controller 210-4 at the completion of commissioning such that controller 210-4 can operate lighting system 50-5 independently thereafter (e.g., without an ongoing connection to server 710). In these and other embodiments, app 620 and/or controller 210-4 may be capable of importing CAD file 760, from server 710 or other sources, that defines surfaces of buildings or other installations that can be identified as space 30.

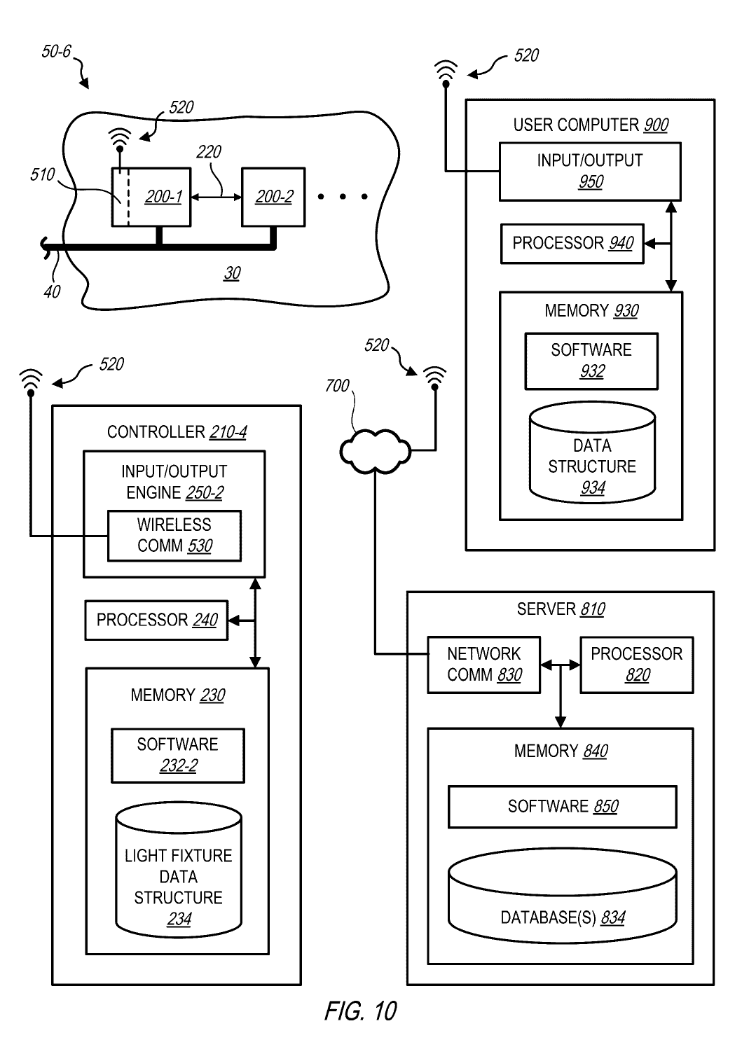

FIG. 10 illustrates a lighting system 50-6 that wirelessly connects controller 210-4 and a user computer 900 with multiple light fixtures 200-1, 200-2, with access to software and/or data facilitated by connections to the Internet 700. User computer 900 is shown with a processor 940, input/output 950 (shown connecting with wireless signals 520, although other forms of connectivity are contemplated), and memory 930 that holds at least software 932, and optionally a data structure 934. Software 932 may for example provide user computer 900 with the same functionality as app 620 provides to user device 600 (FIGS. 7, 8 and 9). Only certain features of server 810 are shown in FIG. 10, for clarity of illustration; these include a processor 820, network communications 830 and memory 840 holding software 850 and optional database(s) 834. Server 810 functions in the same manner as server 710, FIG. 9; that is, server 810 may store and/or provide software to controller 210-4 and/or user computer 900, may assemble and/or store an online light fixture data structure as one of databases 834, may provide a CAD file as one of databases 834 to controller 210-4 and/or user computer 900, and the like. Again, although signals 520 are shown connecting all of light fixture 200-1, controller 210-4, user computer 900 and server 810, in embodiments multiple types of wireless signals may be utilized, and some (or all) of the devices shown may connect via physical wiring.

User computer 900 may include other features than are shown in FIG. 10, but one skilled in the art will understand, upon reviewing FIG. 10 along with FIG. 9, that user computer 900 may be substituted for user device 600, FIG. 9, to provide the same functionality for commissioning light fixtures as described with respect to user device 600 in FIG. 9. For example, user computer 900 can provide user interface functionality while working with controller 210-4 to commission light fixtures in space 30, and/or may assemble a light fixture data structure during the commissioning process, and download the completed data structure to controller 210-4 when the commissioning process is complete.

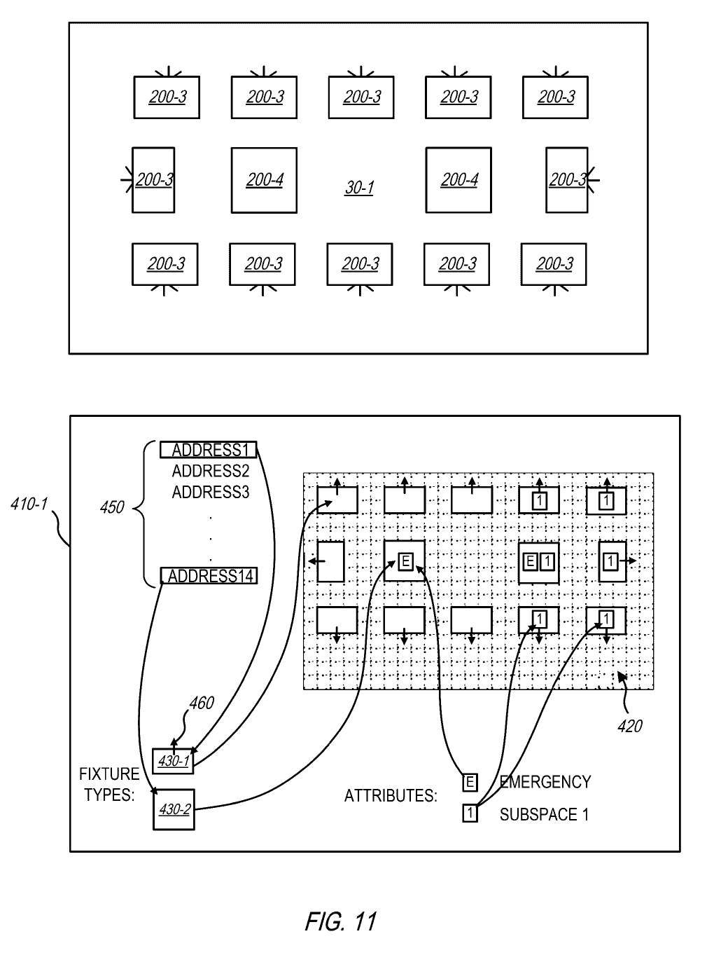

In embodiments, characteristics of light fixtures other than position are also entered into a light fixture database. For example, FIG. 11 schematically illustrates a space 30-1 in which two types of light fixtures 200-3, 200-4 are installed, and use of GUI 410 to capture orientation and other attribute information, as well as position information. Light fixtures 200-3 feature an orientation, that is, light fixtures 200-3 have an appearance or light emission attributes that are particular to a direction. For example, light fixtures 200-3 might be multiple component light fixtures as described in FIG. 1 or in the Applications, supra, that can provide horizontal and/or vertical gradients of light, or “wall wash” light fixtures that preferentially emit light onto an adjacent wall, so as to illuminate an artwork. Thus, space 30-1 may be a ceiling, and light fixtures 200-3 installed therein may be asymmetric in shape or appearance, and/or provide asymmetric light output; as suggested in FIG. 11, light fixtures 200-3 project light toward edges of space 30-1 (e.g., toward walls adjacent to the edges of space 30-1). When the installation illustrated in space 30-1 is commissioned, a controller needs to store information corresponding not only to where the light fixtures therein are located, but sometimes, what type each fixture is, in which direction(s) are certain fixtures oriented, which of the light fixtures are designated as emergency light fixtures, which of the light fixtures has some other user-defined attribute, and the like.

Thus, representations of light fixtures can be provided that allow the user to indicate features such as orientation. For example, in FIG. 11, representation 430-1 includes a short, straight arrow “handle” indicating orientation of the associated light fixture type. The arrow shown can be engaged in the GUI by clicking on it and dragging it around representation 430-1 to rotate the icon until the “handle” is pointing in the desired direction.

FIG. 11 illustrates an alternative scheme for identifying light fixtures, as compared with the method illustrated in FIG. 4. As shown in FIG. 11, GUI 410-1 provides a list 450 of light fixture addresses that are known to an associated controller (e.g., controller 210), and a representation 430 for each available light fixture type. Each address can be assigned a color that approximates a color being emitted by the light fixture at the corresponding address, or one address at a time can be selected by the user by clicking on it in GUI 410-1, with the corresponding selected light fixture being turned on brightly, blinking or the like to differentiate it from other light fixtures. List 450 and representations 430 may be generated by the controller by polling light fixtures 200 (e.g., using the DMX/RDM protocol to ask light fixtures 200 to identify themselves by address and/or type) or by importing a list of addresses and types associated with a specific light fixture kit known to the controller. However, in certain embodiments the information provided by light fixtures 200 is minimal, such that DMX/RDM responses by light fixtures 200 reveal only a count and electronic address for each light fixture 200. In still other embodiments, light fixtures 200 are not DMX/RDM compatible, that is, they may obey commands sent according to DMX protocol (e.g., turn on, turn off, display a certain color, etc.) but do not respond with information as per DMX/RDM. In these embodiments, the associated controller must be provided separately with a count and DMX addresses for light fixtures that it will be addressing. The scheme illustrated in FIG. 11 may be considered a “custom” setup that involves more user interaction than the schemes represented in other drawings herein. As such, it may be utilized primarily in applications in which low cost of light fixtures 200 is important, such that light fixtures 200 are not provided with full DMX/RDM functionality but instead are provided with addresses that are known to a controller shipped with the light fixtures.

Once a set of light fixture addresses is known by any of the above techniques, a user can associate each listed address and a specific light fixture type with a specific, installed light fixture by indicating the association within GUI 410, e.g., by “dragging and dropping” each address onto an appropriate light fixture type icon, then “dragging and dropping” the icons to an appropriate grid location, as suggested by long, curving arrows in FIG. 10. In embodiments, GUI 410-1 can provide helpful cues such as deleting or marking addresses in list 450 once each such address is associated with a representation 430 in grid 420, repopulating icons representing types of light fixtures as often as “copies” of the icons are dragged into grid 420, and deleting any representation 430 that is marked by the user as inadvertently entered. The user can orient the icon if necessary by dragging its orientation “handle” so that the final arrangement shown within grid 420 accurately reflects the number, type, location and orientation of all the installed light fixtures. The user can also drag and drop attribute indicators on the appropriate icons, as also suggested by long, curving arrows. FIG. 10 shows examples of certain light fixtures of an installation being marked as emergency lights and as lights defined as being within a user-defined subspace (e.g., a portion of a conference center meeting room or ballroom); other types of attributes may be defined and associated with icons that can be dragged and dropped onto the light fixture icons. Light fixture icons can be associated with addresses or attributes either before or after they are dragged into grid 420.

The foregoing is provided for purposes of illustrating, explaining, and describing various embodiments. Having described these embodiments, it will be recognized by those of skill in the art that various modifications, alternative constructions, and equivalents may be used without departing from the spirit of what is disclosed. Different arrangements of the components depicted in the drawings or described above, as well as additional components and steps not shown or described, are possible. Certain features and subcombinations of features disclosed herein are useful and may be employed without reference to other features and subcombinations. Additionally, a number of well-known processes and elements have not been described in order to avoid unnecessarily obscuring the embodiments. Embodiments have been described for illustrative and not restrictive purposes, and alternative embodiments will become apparent to readers of this patent. Accordingly, embodiments are not limited to those described above or depicted in the drawings, and various modifications can be made without departing from the scope of the claims below. Embodiments covered by this patent are defined by the claims below, and not by the brief summary and the detailed description.

What is claimed is:

1. A method of commissioning a plurality of light fixtures located in a space, the method comprising:
controlling a user interface to provide a display of:
a representation of the space, and
representations of each of the plurality of light fixtures;
controlling light emitted by at least a subset of the light fixtures, such that each of the light fixtures is distinguishable from others of the light fixtures,
controlling the user interface such that the representation of each of the light fixtures is distinguishable from the representations of the others of the light fixtures,
receiving input from the user interface as information that specifies a position of each of the light fixtures within the space; and
storing the information that specifies the position of each of the light fixtures within the space, in a data structure.

2. The method of claim 1, wherein controlling light emitted by at least the subset of the light fixtures comprises causing a controller to control at least one of the light fixtures to emit light of a color that is distinguishable from colors of light emitted by the others of the light fixtures.

3. The method of claim 2, wherein controlling the user interface such that the representation of each of the light fixtures is distinguishable from the representations of the others of the light fixtures comprises causing the representation of the at least one of the light fixtures to be displayed, in the user interface, with an approximation of the color that is distinguishable from the colors of light emitted by the others of the light fixtures.

4. The method of claim 2, wherein controlling the user interface to display the representation of the space and the representations of each of the plurality of light fixtures comprises displaying the representation of the space, and the representations of each of the plurality of light fixtures, through a user interface of the controller.

5. The method of claim 2, wherein controlling the user interface to display the representation of the space and the representations of each of the plurality of light fixtures comprises sending information of the space and of the plurality of light fixtures to a user device that includes a visual display.

6. The method of claim 5, further comprising downloading a software app to the user device, that when executed, causes the user device to perform the steps of:
controlling the user interface such that the representation of each of the light fixtures is distinguishable from the representations of the others of the light fixtures, and
receiving the input from the user interface.

7. The method of claim 6, wherein downloading the software app to the user device comprises downloading the software app from the controller.

8. The method of claim 6, wherein downloading the software app to the user device comprises downloading the software app, over a network, from a server to the user device.

9. The method of claim 1, wherein the user interface includes a pointing device, such that receiving input from the user interface comprises receiving information from the pointing device, and further comprising:
causing the information that specifies the position to be modified according to the information received from the pointing device, and
causing the modified information that specifies the position to be reflected within the representation of the space in the user interface.

10. The method of claim 9, wherein:
the pointing device comprises a touch screen, and
receiving input from the user interface as information that specifies a position of each of the light fixtures within the space comprises determining registration of each of the representations of the light fixtures with the representation of the space in the touch screen.

11. The method of claim 9, wherein:
controlling the user interface to provide the display of the representation of the space and the representations of each of the plurality of light fixtures, comprises causing the user interface to initially display the representation of the one of the light fixtures separately from the representation of the space, and
receiving the input from the user interface includes receiving input from the pointing device that:
selects at least one of the plurality of light fixtures, and
indicates the position of the at least one of the plurality of light fixtures within the representation of the space.

12. The method of claim 9, wherein controlling the user interface to display the representation of the space and the representations of each of the plurality of light fixtures, comprises controlling the user interface to display a grid, and further comprising:
associating the information that specifies the position for at least one of the light fixtures, in the data structure, with a position in the grid that is nearest to a position indicated with the pointing device.

13. The method of claim 12, wherein controlling the user interface to display the grid comprises controlling the user interface to display a smallest resolution of the grid as being about equal in dimension to a smallest dimension of the representation of the one of the light fixtures.

14. The method of claim 12, wherein controlling the user interface to display the grid comprises controlling the user interface to display a smallest resolution of the grid as being less than or equal to half of a smallest dimension of the representation of at least one of the light fixtures.

15. The method of claim 1, wherein controlling the user interface to display the representation of the space comprises controlling the user interface to display a representation generated from a floor plan.

16. The method of claim 1, wherein:
at least one of the light fixtures is capable of producing light in a pattern characterized by an orientation;
at least one of the representations of each of the plurality of light fixtures is a representation that indicates the orientation of the one of the light fixtures; and
further comprising:
receiving input from the user interface as information that specifies an orientation of the at least one of the light fixtures within the space; and
storing the information that specifies the orientation of the at least one of the light fixtures, in the data structure.

17. The method of claim 1, further comprising:
receiving input from the user interface as information that specifies an attribute of at least one of the light fixtures within the space; and
causing the information that specifies the attribute of the at least one of the light fixtures, to be stored in the data structure.

18. The method of claim 1, further comprising:
issuing an electronic command to the plurality of light fixtures; and
receiving responses from the light fixtures in response to the electronic command, the responses providing at least a count of the plurality of light fixtures and electronic addresses of each of the light fixtures.

19. The method of claim 18, wherein the responses provide at least one of wattage, dimension and light fixture type for at least one of the plurality of light fixtures.

20. A software product, comprising instructions stored on non-transitory computer readable media, wherein the instructions, when executed by one or more processors, cause the one or more processors to implement steps of a method for commissioning a plurality of light fixtures located in a space, the instructions comprising:
instructions for controlling a user interface that includes a visual display, to provide a display of:
a representation of the space, and
representations of each of the plurality of light fixtures;
instructions for executing, for at least a subset of the light fixtures:
instructions for causing light fixtures of the subset to emit light that is distinguishable from light emitted by others of the light fixtures,
instructions for causing the representations of each of the subset of the light fixtures to be distinguishable from the representations of others of the light fixtures, in the visual display, and
instructions for receiving input from the user interface as information that specifies a position of each of the subset of the light fixtures within the space; and
instructions for causing the information that specifies the position to be stored in a data structure.

21. A controller for commissioning a light fixture installation, the controller comprising:
a processor;
an input/output engine communicatively coupled with the processor, that includes:
a user interface having a display and an input device, and
a light fixture output engine that generates commands for controlling a plurality of light fixtures; and
a memory communicatively coupled with and readable by the processor, wherein the memory stores:
a light fixture data structure, and
processor-readable instructions that, when executed by the processor, cause the processor to:
display, through the user interface, a representation of a space and representations of each of the plurality of light fixtures,
control one of the plurality of light fixtures, through the light fixture output engine, such that the one of the light fixtures emits light that is distinguishable from light emitted by others of the light fixtures,
accept input, from the input device, as information that specifies a position of the one of the light fixtures within the space, and
store the information that specifies the position, in the light fixture data structure.
